(19) United States
(12) Patent Application Publication
(10) Pub. No.: US 2006/0140424 A1
(43) Pub. Date: Jun. 29, 2006

(54) Piezoelectric panel speaker

(75) Inventor: Kazuhiro Kobayashi, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd.

(21) Appl. No.: 11/318,959

(22) Filed: Dec. 27, 2005

(30) Foreign Application Priority Data
Dec. 27, 2004 (JP) JP2004-377897

(51) Int. Cl. H04R 25/00

(52) U.S. Cl. 381/190; 381/431

(57) ABSTRACT

A piezoelectric panel speaker improved in frequency characteristics has a panel and a piezoelectric exciter for vibrating the panel. The exciter includes a casing and a piezoelectric exciter element accommodated in the casing. The casing has an outer surface with a part positioned proximate to and facing one side surface of the panel. The side surface of the panel has an area opposed to the part of the outer surface of the exciter. A securing layer is partially formed between the area of the panel and the part of the outer surface to secure the exciter to the panel. The securing layer is made of a material so that vibration is transmittable from the exciter to the panel.

This application claims priority under 35 U.S.C. §119 to Japanese Patent Application No. 2004-377897 filed Dec. 27, 2004, the entire content of which is hereby incorporated by reference.

### BACKGROUND OF THE INVENTION

1. Field of the Invention

The present invention relates to panel speakers and, more particularly, to a panel speaker using a piezoelectric exciter.

2. Description of the Background Art

A panel speaker is a thin loudspeaker including a panel diaphragm (vibration panel) and an exciter that vibrates the diaphragm to generate sound. The panel speaker is used, for example, in cellular phones [see Japanese Patent Application Publication (KOKAI) No. 2004-336403]. FIG. 7 is a plan view showing the arrangement of the display part of such a cellular phone. The display part of the cellular phone has a liquid crystal panel 2 set in a casing 1, a speaker vibration panel 3 also serving as a light-transmitting protection panel that is set to close a display opening formed in the casing 1, and an exciter 6 secured to the interior side of the vibration panel 3 to vibrate it. The vibration panel 3 and the exciter 6 constitute in combination a panel speaker.

Exciters generally include those using electromagnetic coils and those using piezoelectric elements. There has been developed the following exciter using a piezoelectric element [see Japanese Patent Application Publication No. 2005-160028; Japanese Patent Application No. 2003-189935]. A thin piezoelectric layer is formed on either or both sides of a thin metal sheet to construct an exciter element. The exciter element is supported in such a manner that only a portion thereof is secured. In this state, an acoustic signal voltage is applied to the exciter element to vibrate a portion thereof extending from the secure portion to the free end thereof, thereby vibrating the above-described vibration panel 3 to generate sound. The exciter element is accommodated within a casing to protect it.

FIG. 8 shows a type of piezoelectric exciter 10. Two piezoelectric exciter elements b1 and b2 are supported in cantilever fashion by adhesive layers f in two chambers formed in a rectangular casing c. Signal voltages are applied to the piezoelectric exciter elements b1 and b2 through terminals t1 and t2, thereby vibrating the portions of the piezoelectric exciter elements b1 and b2 extending from the portions fixed by the adhesive layers f to the respective free ends.

FIGS. 9 and 10 show a panel speaker using a piezoelectric exciter 20 of another type. The illustrated speaker includes a vibration panel 3 having a liquid crystal panel 2 connected thereto through a soft spongy material (not shown) or the like, and a piezoelectric exciter 20 secured to the vibration panel 3 with an adhesive 8 or the like. The piezoelectric exciter 20 has two piezoelectric exciter elements B1 and B2 (see FIG. 10) installed in an elongated casing. The casing has a top portion 20a, a bottom portion 20b, an exciter element supporting portion 20d provided between the top portion 20a and the bottom portion 20b (at the center as viewed in FIG. 10 which shows a back side of the exciter 20), and column portions 20e connecting together the top portion 20a and the bottom portion 20b (at right and left end positions on the front and back side edges of the exciter).

As viewed in FIG. 10, the exciter elements B1 and B2 extend through and are supported at their central portions by the supporting portion 20d. In the illustrated example, the exciter element B1 is shorter in length than the exciter element B2.

The piezoelectric exciter is secured to the vibration panel in such a manner that substantially the entire lower surface of the casing of the piezoelectric exciter is bonded to the vibration panel to prevent the piezoelectric exciter from being detached from the vibration panel easily even if an impact is applied thereto upon a fall or other incident.

With the above-described structure, the panel speaker has difficulty in obtaining a favorably flat frequency characteristic curve and hence suffers from inferior acoustic characteristics. Meanwhile, it is difficult to add an adjusting mechanism for tone control under constraints such as the demand for miniaturization of devices.

### SUMMARY OF THE INVENTION

The present invention was made in view of the above-described circumstances. Accordingly, an object of the present invention is to provide a panel speaker using a piezoelectric exciter and improved in frequency characteristics.

The present invention provides piezoelectric panel speaker comprising a panel having opposite side surfaces, and a piezoelectric exciter for vibrating the panel. The exciter includes a casing and a piezoelectric exciter element accommodated in the casing. The casing has an outer surface a part of which is positioned proximate to and facing one of the opposite side surfaces of the panel, the part having a securing portion and a rest portion. The one of the side surfaces has an area opposed to the part of the outer surface which area has a securing portion and a rest portion. A securing layer is formed between the securing portions of the area and the part of the outer surface and adapted to secure the exciter to the panel. The securing layer is made of a material so that vibration is transmittable from the exciter to the panel.

In the piezoelectric panel speaker, the vibration panel is securely supported by only a small portion as compared with piezoelectric exciters explained with reference to FIGS. 8-10 in which entire lower surfaces of the exciters are secured to vibration panels. This enables the frequency characteristics of the vibration panel to be improved. Further, the frequency characteristics can change according to the area ratio of the securing portion to the rest of the vibration panel. Therefore, the frequency characteristics can be adjusted by changing the area ratio.

Specifically, in the piezoelectric panel speaker, an auxiliary layer may be at least partially disposed between and connected to the above stated rest portions The auxiliary layer may be made of a yieldable material.

More specifically, the exciter element has a portion secured to the casing and at least one vibration portion extending from said secured portion to its free end. The securing portions above are aligned with the above stated secured portion of the exciter element in a direction perpendicular to the one of the opposite side surfaces of the panel.

Even more specifically, the casing has opposite end portions in a direction parallel to the above stated one of the opposite surfaces of the panel. The secured portion of the exciter element may be positioned at one of the opposite end portions of the casing. The exciter element may have a vibration portion extending from the secured portion toward the other of the opposite end portions of the casing. Alternatively, the secured portion of the exciter element may be positioned at the central portion of said casing between the opposite end portions and the exciter element may have two vibration portions extending from the secured portion toward the opposite end portions of the casing.

The securing layer may comprise a double sided adhesive tape obtained by applying an adhesive to both sides of a tape material made of a high-elasticity material. The auxiliary layer may comprise a double sided adhesive tape obtained by applying an adhesive to both sides of a tape material made of a cushiony or yieldable material, e.g., sponge.

Other objects and advantages of the present invention will become apparent from the following detailed description of illustrated embodiments of the invention.

### BRIEF DESCRIPTION OF THE DRAWINGS

FIG. 1 is a perspective view of a panel speaker according to a first embodiment of the present invention.

FIG. 2 is a sectional view taken along the line II-II in FIG. 1.

FIG. 3 is a sectional view of a panel speaker according to a second embodiment of the present invention.

FIG. 4 is a sectional view of a panel speaker according to a third embodiment of the present invention.

FIG. 5 is a sectional view of a panel speaker according to a fourth embodiment of the present invention.

FIG. 6 is a graph showing comparatively experimental data on sound pressure level-frequency characteristics of the panel speaker according to the first embodiment of the present invention and those of a panel speaker having a conventional structure.

FIG. 7 is a plan view showing the display part of a cellular phone equipped with a conventional panel speaker.

FIG. 8 is a sectional view showing an example of a piezoelectric exciter mounted on a conventional panel speaker.

FIG. 9 is a perspective view of a conventional panel speaker.

FIG. 10 is a sectional view taken along the line X-X in FIG. 9.

FIGS. 11 a plan view of a modification of the panel speaker shown in FIG. 3 or FIG. 5 in which a vibration panel and a liquid crystal panel are shown by chain lines to show a positional relationship of the piezoelectric exciter relative to the vibration panel and the liquid crystal panel.

FIG. 12 is a side elevation view of the piezoelectric exciter of FIG. 11.

FIG. 13 is a bottom view of another modification of the panel speaker shown in FIG. 3 or FIG. 5.

FIG. 14 is a side elevation view of the panel speaker of FIG. 13.

FIG. 15 is a side elevation view of a piezoelectric exciter according to another embodiment of the present invention.

FIG. 16 is a side elevation view of a modification of the piezoelectric exciter of FIG. 14.

FIG. 17 is a side elevation view of a modification of the piezoelectric exciter of FIG. 12.

### PREFERRED EMBODIMENTS

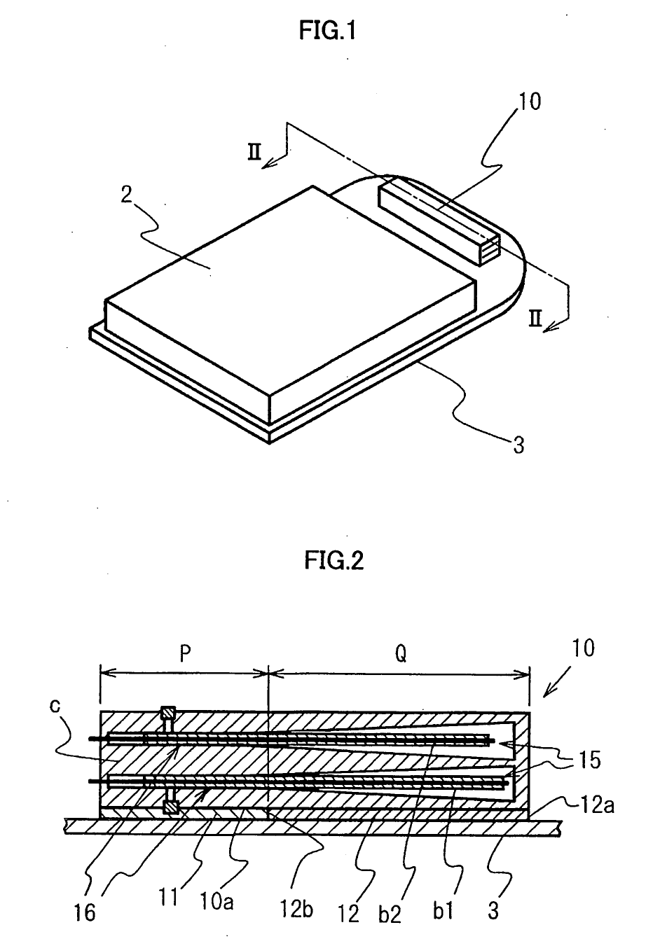

The present invention will now be described with reference to FIGS. 1 to 5

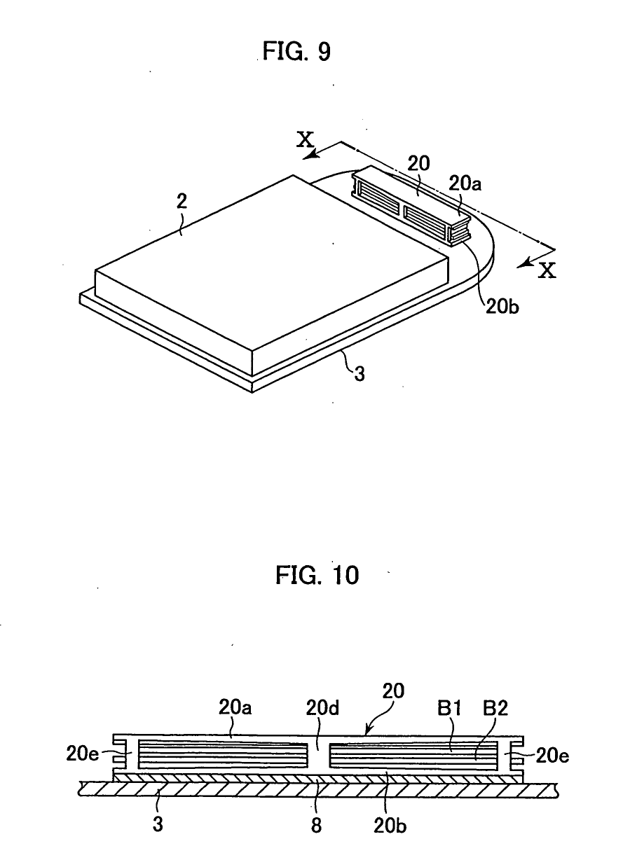

FIG. 1 shows a panel speaker according to a first embodiment of the present invention. The panel speaker includes, as in the panel speaker explained above with reference to FIG. 9, a vibration panel 3, a liquid crystal panel 2 connected thereto through a soft spongy material (not shown) or the like and a piezoelectric exciter 10 secured to the vibration panel 3. The piezoelectric exciter 10 has two exciter elements b1 and b2 accommodated in a rectangular casing c. The casing c and the vibration panel may be made from acrylic resin. The piezoelectric exciter 10 has substantially the same arrangement as that of the piezoelectric exciter explained above with reference to FIG. 8. Therefore, a detailed description thereof is omitted.

As shown in FIG. 2, the piezoelectric exciter 10 is divided into a first region P and a second region Q. In the first region P, one end portion 16 of each of the exciter elements b1 and b2 is secured to the casing c. In the second region Q, the exciter elements b1 and b2 extend to their free ends 15 and can vibrate in respective chambers formed in the casing c. In the first region P, the lower surface 10a of the casing c is secured to the vibration panel 3 with a securing member or layer 11 so that vibration is transmitted from the exciter to the panel 3. In the second region Q, a cushiony or yieldable insert 12 is adhesively connected between the lower surface 10a of the piezoelectric exciter 10 and the vibration panel 3 so that the insert 12 yieldably supports the exciter 10 on the vibration panel 3.

More specifically, the securing member 11 may comprise a double-sided adhesive tape obtained by applying an adhesive to both sides of a tape material made of a high-elasticity material. The insert 12 may comprise a double-sided adhesive tape obtained by applying an adhesive to both sides of a tape material made of a cushiony or yieldable material, e.g., sponge.

In the piezoelectric exciter 10, it is therefore possible to minimize the restraint imposed by the piezoelectric exciter 10 on the vibration of the vibration panel 3 at the second region Q and hence possible to improve the frequency characteristics of the vibration panel 3.

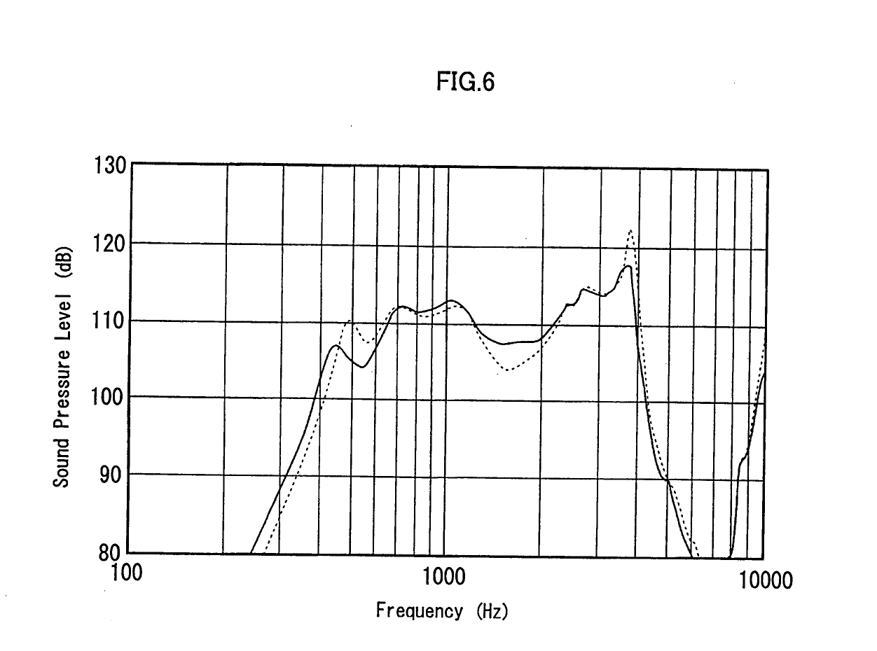

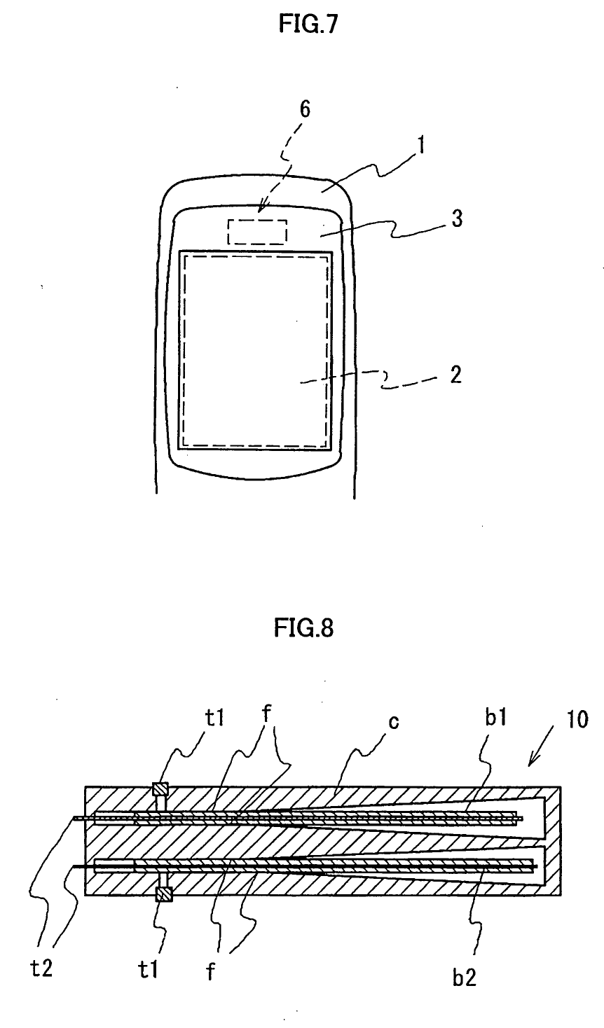

In the graph of FIG. 6, the solid line shows the sound pressure level-frequency characteristics of the panel speaker of FIGS. 1 and 2 obtained when it was used in a cellular phone. The broken line shows the sound pressure level-frequency characteristics of the panel speaker in which the entire lower surface of the same piezoelectric exciter as shown in FIG. 2 was secured to the vibration panel 3 with double-sided adhesive tape 11 having high elasticity.

As will be understood from the graph, in the panel speaker according to this embodiment, the sound pressure level in the frequency regions of 500 Hz or less and from 1 to 2 kHz rises, and the peak of sound pressure level in the frequency region of 3 to 4 kHz is suppressed. Consequently, the sound pressure level-frequency characteristic curve is favorably flat as a whole. In order to improve the acoustic characteristics, it is preferable that the area of the first region P is in the range between twenty percent and eighty percent of the entire lower surface of the exciter casing. More preferably, the area of the first region P is less than fifty percent.

The acoustic characteristics of the panel speaker according to this embodiment change in relation to the dimension of the insert or double-sided adhesive tape 12 shown in FIG. 2, i.e. the length of the adhesive tape 12 from its one end 12a to the other end 12b. Accordingly, the acoustic characteristics can be adjusted by changing the length of the insert 12 from its one end 12a to the other end 12b. That is, it is possible to adjust the acoustic characteristics by changing the ratio of the area of the first region P to the area of the second region Q.

As has been stated above, the panel speaker according to this embodiment can improve the flatness of sound pressure level in a frequency band generally required for speaker characteristics, i.e. 300 Hz to 4 kHz used in cellular phones. Further, because the yieldable or cushiony insert or double-sided tape is disposed between the lower surface 10a of the piezoelectric exciter 10 and the vibration panel, it is possible to maintain the desired resistance to impact caused by a fall of the device or other incident. However, it should be noted that the insert may be disposed partially in the region Q between the lower surface 10a of the piezoelectric exciter 10 and the vibration panel 3.

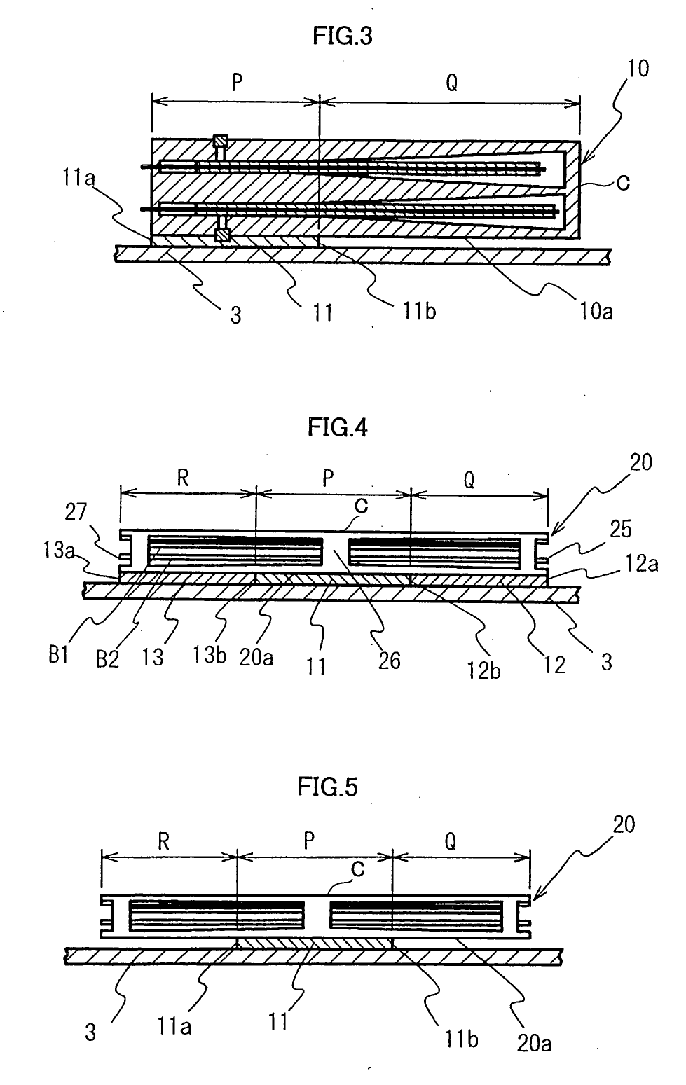

FIG. 3 illustrates a second embodiment of the present invention, which is a modification of the panel speaker shown in FIG. 2. In the panel speaker shown in FIG. 3, the first region P of the lower surface 10a of the piezoelectric exciter 10 is secured to the vibration panel 3 with double-sided adhesive tape 11 having high elasticity. At the second region Q, a space is provided between the piezoelectric exciter 10 and the vibration panel 3. In this case also, the acoustic characteristics of the panel speaker change in relation to the dimension of the high-elasticity double-sided adhesive tape 11 from its one end 11a to the other end 11b. Therefore, the acoustic characteristics can be adjusted by changing the length of the double-sided adhesive tape 11.

FIG. 4 is a sectional view of a panel speaker according to a third embodiment of the present invention. The panel speaker uses a piezoelectric exciter 20 having the same arrangement as that of the piezoelectric exciter explained above with reference to FIG. 10. That is, the piezoelectric exciter 20 has a retainer portion 26 formed in a central region of the casing to retain the respective central portions of the exciter elements or beams B1 and B2. The exciter elements extend to the right and left free ends 25 and 27 thereof.

In the piezoelectric exciter 20, the casing is divided into a central first region P where the exciter elements B1 and B2 are securely held and second regions Q and R on the right and left sides of the first region P.

At the first region P, the casing is secured to the vibration panel 3 with a securing member 11 having high elasticity in the same way as in the first embodiment. At the right and left second regions Q and R, cushiony or yieldable inserts 12 and 13 are adhesively connected between the exciter casing and the vibration panel 3.

More specifically, the securing member 11 may be formed by using double-sided adhesive tape obtained by applying an adhesive to both sides of a tape material made of a high-elasticity material. The yieldable inserts 12 and 13 may be formed by using double-sided adhesive tape obtained by applying an adhesive to both sides of a tape material made of a yieldable material, e.g., sponge.

In the piezoelectric exciter 20, because the second regions Q and R are arranged as stated above, it is possible to minimize the restraint on the vibration of the vibration panel 3 at these regions Q and R and hence possible to improve the frequency characteristics of the vibration panel 3.

The acoustic characteristics of the panel speaker according to this embodiment change in relation to the length of each yieldable insert (from 12a to 12b; from 13a to 13b). In other words, the acoustic characteristics change in relation to the length of the high-elasticity securing member 11. Accordingly, the acoustic characteristics of the panel speaker can be adjusted by changing the lengths of the securing members and/or inserts. Thus, it is possible to improve the flatness of the sound pressure level in a frequency band generally required for speaker characteristics, i.e. 300 Hz to 4 kHz used in cellular phones, as in the case of the first embodiment. Further, because the lower surface 20a of the piezoelectric exciter 20 is connected to the vibration panel 3 as a whole, the desired impact resistance can be maintained.

FIG. 5 illustrates a fourth embodiment of the present invention, which is a modification of the panel speaker shown in FIG. 4. In the panel speaker shown in FIG. 5, the first region P of the bottom 20a of the piezoelectric exciter 20 is secured to the vibration panel 3 with a securing member or double-sided adhesive tape 11 having high elasticity. In the second regions Q and R, a space is formed between the piezoelectric exciter 20 and the vibration panel 3. In this case also, the acoustic characteristics of the panel speaker change in relation to the dimension of the securing member or double-sided adhesive tape 11 from its one end 11a to the other end 11b. Therefore, the acoustic characteristics can be adjusted by changing the length of the double-sided adhesive tape 11.

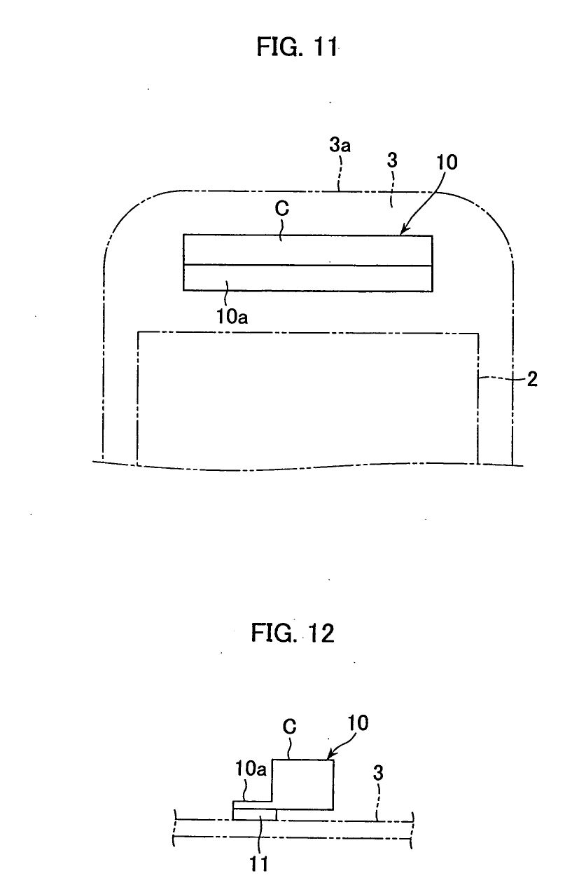

It should be noted that the present invention is not necessarily limited to the foregoing embodiments but can be modified in a variety of ways without departing from the gist of the present invention. FIGS. 11-16 show such modifications.

FIGS. 11 and 12 illustrate a modification of the panel speaker shown in FIG. 3. In this embodiment, the exciter 10 is provided with a bracket 10a integrally formed with and extending from a lower side edge portion of the rectangular casing c thereof toward the liquid crystal panel 2 in parallel to the vibration panel 3. A securing member 11 is disposed generally between the bracket 10a and the vibration panel 3. This arrangement will make it possible to improve the frequency characteristics of the vibration panel 3 as compared with an arrangement in which the securing member 11 is provided closer to an end peripheral edge 3a of the vibration panel 3. Even if the casing c is not provided with the bracket, it is preferable to improve frequency characteristics of the vibration panel 3 that the securing member 11 is, as shown in FIG. 17, provided at a position spaced apart from one of the lower side edge portions of the casing c which is closer to the end peripheral edge 3a of the vibration panel 3 than the other of the lower side edge portions.

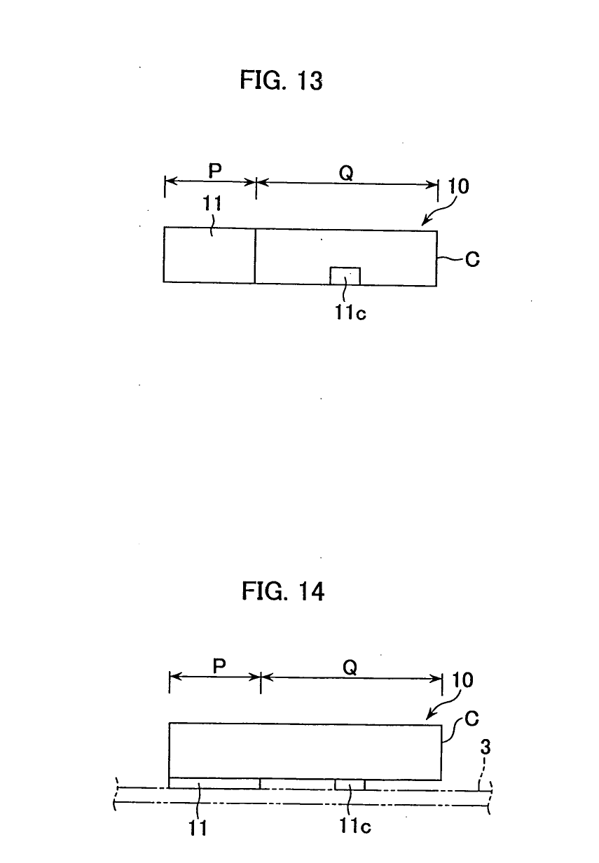

FIGS. 13 and 14 illustrate a modification of the panel speaker shown in FIG. 3. In this embodiment, in the region Q, there is provided with an additional securing member 11c.

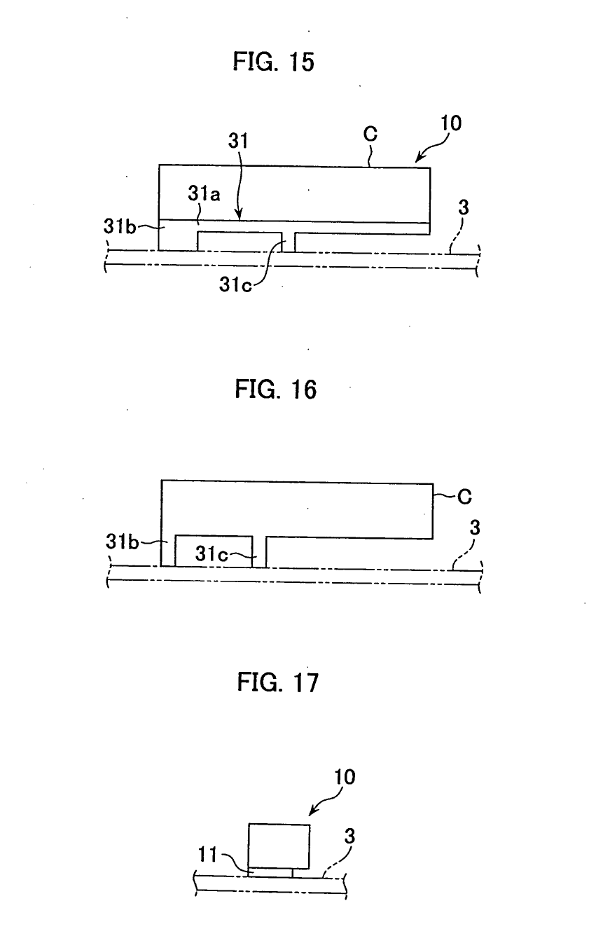

FIG. 15 shows another embodiment of the present invention in which between the exciter casing c and the vibration panel 3 is connected a securing member 31 which is made of a high-elasticity material and has a flat portion 31a adhered to the entire lower surface of the exciter casing c and first and second securing portions 31b and 31c extending from the flat portion 31a toward and welded to the vibration panel 3. It is preferable that the securing member 31 and the panel 3 are made from the same material, for example, acrylic resin.

FIG. 16 shows a modification of the embodiment of FIG. 15 in which the first and second securing portion 31b and 31c are integrally formed with the exciter casing c and welded to the vibration panel.

Although the present invention has been described in terms of specific embodiments, it is anticipated that alternations and modifications thereof will no doubt become apparent to those skilled in the art. It is therefore intended that the following claims be interpreted as covering all such alternations and modifications as fall within the true sprit and scope of the invention.

What is claimed is:

1. A piezoelectric panel speaker comprising:
a panel having opposite side surfaces;
a piezoelectric exciter for vibrating said panel, said exciter including a casing and a piezoelectric exciter element accommodated in said casing, said casing having an outer surface with a part positioned proximate to and facing one of said opposite side surfaces, said part having a securing portion and a rest portion;
said one of said side surfaces having an area opposed to said part of said outer surface, said area having a securing portion and a rest portion; and,
a securing layer formed between said securing portions of said area and said part of said outer surface and adapted to secure said exciter to said panel, said securing layer being made of a material so that vibration is transmittable from said exciter to said panel.

2. A piezoelectric panel speaker according to claim 1, wherein an auxiliary layer is at least partially disposed between and connected to said rest portions of said area and said part of said outer surface.

3. A piezoelectric panel speaker according to claim 2, wherein, said auxiliary layer is made of a yieldable material.

4. A piezoelectric panel speaker according to claim 1, wherein
said exciter element has a portion secured to said casing and at least one vibration portion extending from said secured portion to its free end; and,
said securing portions of said area and said part of said outer surface are aligned with said secured portion of said exciter element in a direction perpendicular to said one of said opposite side surfaces of said panel.

5. A piezoelectric panel speaker according to claim 4, wherein
said casing has opposite end portions in a direction parallel to said one of said opposite surfaces of said panel;
said secured portion of said exciter element is positioned at one of said opposite end portions of said casing; and,
said exciter element has two vibration portions extending from said secured portion toward the other of said opposite end portions of said casing.

6. A piezoelectric panel speaker according to claim 4, wherein
said casing has opposite end portions in said direction and a central portion between said opposite end portions;
said secured portion of said exciter element is positioned at said central portion of said casing; and,
said exciter element has two vibration portions extending from said secured portion toward said opposite end portions of said casing.

7. A piezoelectric panel speaker according to claim 1, wherein said securing layer comprises a double sided adhesive tape.

8. A piezoelectric panel speaker according to claim 2, wherein said securing layer comprises a double sided adhesive tape and said auxiliary layer comprises a double sided adhesive tape.

9. A piezoelectric panel speaker according to claim 3, wherein said auxiliary layer comprises sponge.
